(19) United States
(12) Patent Application Publication
(10) Pub. No.: US 2021/0027567 A1
(43) Pub. Date: Jan. 28, 2021

(54) APPARATUS AND METHOD FOR ARRANGING DOCUMENTS OF VALUE

(71) Applicant: GIESECKE+DEVRIENT CURRENCY TECHNOLOGY GMBH, munchen (DE)

(72) Inventor: Michael STAPFER, Neubiberg (DE)

(21) Appl. No.: 16/062,757

(22) PCT Filed: Dec. 15, 2016
(86) PCT No.: PCT/EP2016/002113

§ 371 Date: Jun. 15, 2018

(30) Foreign Application Priority Data
Dec. 16, 2015 (DE) 10 2015 016 379.5

(51) Int. Cl. G07D 11/17; G07D 11/14; G07D 11/40

(52) U.S. Cl. CPC G07D 11/17; G07D 11/40; G07D 11/14

(57) ABSTRACT

What is described is an apparatus for arranging value documents, having a work surface, on which value documents to be arranged can be placed, and a trough in or in front of the work surface, which trough is configured such that value documents picked up or pushed from the work surface can be brought into said trough in order to mutually align them therein.

The present invention relates to an apparatus and a method for arranging value documents.

Value documents are understood here as sheet-shaped objects which represent a monetary value or an authorization, for example, and which are consequently not intended to be producible at will by unauthorized persons. Hence, they have features that are not easy to produce, in particular copy, whose presence is an indication of authenticity, i.e. production by an entity authorized to do so. Important examples of such value documents are chip cards, coupons, vouchers, checks and in particular bank notes.

Many entities, for example stores or banks, frequently accept value documents, in particular banknotes. Such an entity frequently packs at least a part of the accepted value documents in a corresponding container, for example in a cassette or in a so-called safebag, a type of bag which can be closed securely, so that unauthorized access to the content is not easily possible. The entity sends the container or containers to organizations that accept the value documents therein, check and count them and subsequently credit the value of the accepted value documents to the sender.

For checking and counting, typically value-document processing apparatus are employed, to which value documents are fed in the form of stacks. The value-document processing apparatus single the value documents of the stack and check the singled value documents. When the value documents of such a stack are misaligned, errors can occur often during the singling, which greatly hampers the check.

The formation of the stack is mostly effected manually. For this purpose, the value documents are emptied from a container onto a work surface and arranged manually, optionally employing the work surface, so that stacks of well-ordered, easy to single value documents are created. However, this formation of stacks, particularly of stacks of well-arranged and/or mutually aligned value documents, is very labor-intensive.

It is therefore the object of the present invention to make available means by which an arrangement of value documents is simplified. Further, a corresponding method is to be stated.

The object is achieved by an apparatus having the features of claim 1 and in particular an apparatus for arranging value documents with a work surface on which value documents to be arranged can be placed, and a trough in or in front of the work surface which is configured such that value documents received by or pushed from the work surface can be brought into said trough in order to mutually align them therein, preferably to arrange them to form a stack.

The work surface can preferably be formed by the surface of a panel, for example of a table top, but other formations are possible as well, for example by the surface of a block. The trough is preferably configured to be straight and longer than the longest value document to be arranged. The depth of the trough is smaller than the smallest extension of the value documents to be processed, i.e. the extension in a direction transverse to the longitudinal direction of the value document or its width.

The trough can be formed directly in the work surface, for example be milled out. However, preferably a recess is present in the work surface, into which a rail is inserted which forms the trough. The rail can be formed from any desired solid material, for example metal, plastic or wood.

For arranging value documents they are more or less ordered and gripped partly one above the other, for example as a non-ordered or poorly ordered packet, and pushed or put into the trough so that the value documents stand on one of their edges or corners. In the trough, they can then be mutually aligned, wherein the trough, more exactly a bottom of the trough, on the one hand serves as a support against gravity, on which the longitudinal edges (or transverse edges) of the value documents can finally stand. On the other hand, the walls of the trough form lateral guides or rests, which prevent tipping of the value documents when they are aligned. The trough and/or its side walls hold value documents once aligned in place, so that this partial task during aligning does no longer be have to be taken over by the hands. Preferably, only as many value documents are put in the trough that these can still be easily moved against each other parallel to their surface in one plane. The value documents can therefore, also manually, be rotated relative to each other and pressed or tapped to the bottom of the trough easily, in order to mutually align and thus arrange them by their longitudinal edges on the support and by their transverse edges through guiding from the side. In this manner, for example, 25 to 50 value documents can be easily aligned and arranged.

Thus arranged value documents can then be removed as a stack. Alternatively, the value documents could also be aligned with their transverse edges on the bottom of the trough.

The object is therefore also achieved by a method for arranging value documents, preferably forming a stack of the value documents, wherein the value documents are placed on a work surface of an apparatus according to the invention, the value documents are moved from the work surface into the trough and the value documents are mutually aligned there in the trough, preferably moved relative to each other such that they eventually stand on the bottom of the trough with a predetermined edge and can be removed from the trough as a stack. The value documents for a stack can be moved into the trough substantially simultaneously or they can be moved into the trough consecutively, wherein if applicable a preliminary and/or partial alignment is effected after insertion of some of the value documents.

In principle, the trough can have any desired profile, for example a V profile. Preferably, in the apparatus the trough can have mutually opposing wall sections which extend substantially parallel to each other. The wall sections here extend in the longitudinal direction of the trough, preferably over the entire length thereof. This configuration offers the advantage that the parallel wall sections allow a particularly good alignment when a larger number of value documents are to be aligned while standing in the trough. Preferably the wall sections adjoin a bottom of the trough; the profile can be U-like then, for example. The spacing of the wall sections is preferably in the range between 20 and 40 mm, but can also be chosen differently. Preferably, these wall sections extend to the bottom of the trough and have a height, i.e. an extension orthogonally to the longitudinal direction, in the range between 30 mm and 50 mm. Other dimensions are possible depending on the size of the value documents to be ordered. A tipping of the value documents is thus prevented also in the case that only few, for example ten, value documents are to be aligned.

When several value documents are moved into the trough simultaneously, the introduction into the trough can be cumbersome. In the apparatus it is therefore preferred that the trough has at least one wall section extending in the longitudinal direction of the trough, which is inclined with respect to the work surface, so that the trough widens upwardly. Particularly preferably, the wall section forms an angle with the work surface of between 15° and 45°. Particularly preferably, this wall section can adjoin one of the parallel wall sections. This further development has the advantage that value documents can be moved easily with one of their edges into the trough, preferably between the parallel wall sections, if present. In particular, they can be pushed or stripped from the work surface into the trough easily. Further, the trough can have two such wall sections on mutually opposing sides of the trough. The width of the trough in the region of the opening of the trough can then preferably be between 100 mm and 120 mm. This is advantageous in particular in a substantially horizontally oriented work surface.

According to a different embodiment the work surface in the apparatus can be inclined in the direction of the trough, so that value documents lying on the work surface can slide at least partially into the trough or can be pushed into the trough when lying on the work surface. This can simplify the insertion of the value documents in the trough.

Further, in the apparatus the work surface can be structured, preferably ribbed or nubby, such that a user can grip with his fingertips below the value documents disposed thereon, and can pick these up more easily.

Especially in safebags, in addition to value documents also coins can be disposed, which drop onto the work surface upon emptying a safebag and which need to be separated from the value documents. A preferred further development of the apparatus therefore provides that the trough has an opening, preferably at one end, wherein there is preferably arranged at the opening a transport device for transporting coins entering through the opening and/or a coin receiving device or a receptacle for a coin receiving device, such that coins dropping through the opening can drop into a coin receiving device received therein. The coin receiving device can be a coin container for receiving coins or a coin processing device, whose coin feed is arranged at the end of the transport device. The transport device can be a hose or a pipe in the simplest case; one end of the hose or pipe is then placed in front of the opening and the other end for example ends at a feed port of a coin collection container or a coin feed of a coin processing device, for example a coin sorter or a coin counter. However, also driven transport devices can be employed, such as conveyor belts. The diameter of the opening or its width is preferably chosen so that it is larger than the diameter of the largest coins typically to be expected. When used in the Euro zone, the opening should for example have a diameter that is larger than the diameter of a 2 Euro coin. This embodiment has the advantage that value documents with coins disposed in between or also only coins can be brought into the trough, where they are separated from the value documents by their weight alone. They can be pushed to the opening in the trough. Preferably, in a further development at least the bottom of the trough is inclined downwardly in the longitudinal direction of the trough, so that the opening is disposed in the region of the lower end. The inclination is particularly preferably chosen such that coins lying on the bottom can slide in the direction of the opening and then through the opening. The inclination angle can preferably be in the range between 5° and 10°.

Another further development of the apparatus consists in that it has a device by means of which the trough can be vibrated. This facilitates the mutual alignment of the value documents or can possibly even cause a self-alignment. Further, in this manner a better separation of coins from the value documents can be obtained.

The invention will hereinafter be explained further by way of example with reference to the drawings. There are shown:

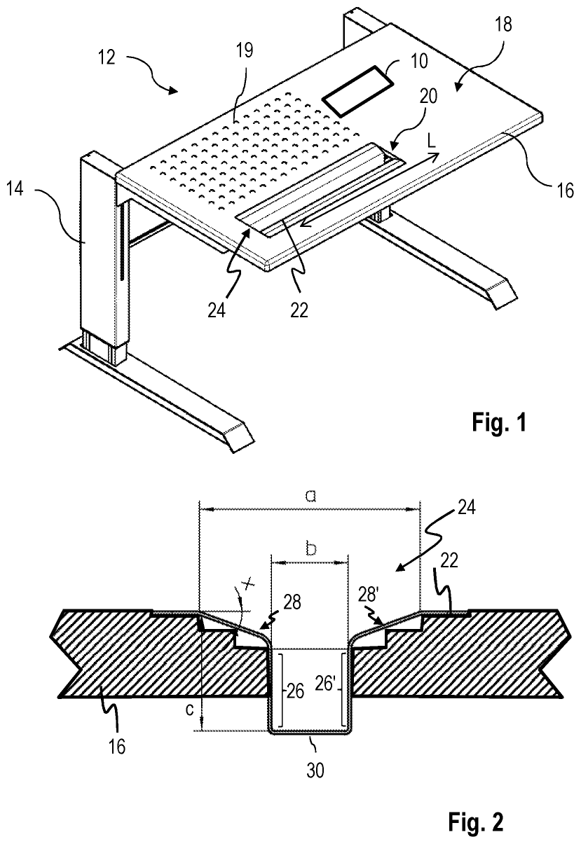

FIG. 1 a perspective schematic view of a first embodiment of an apparatus for arranging value documents,

FIG. 2 a sectional view through a plate of the apparatus in FIG. 1 in the region of a trough,

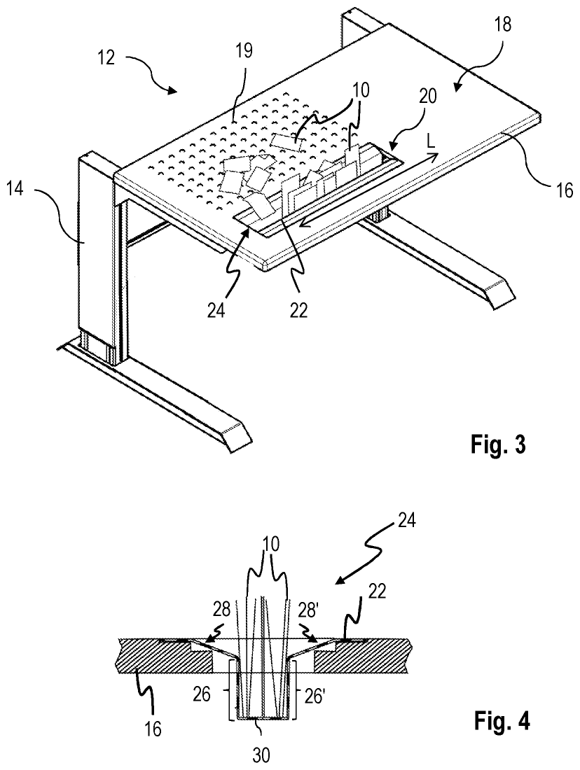

FIG. 3 a view corresponding to FIG. 1, in which value documents are shown while being arranged,

FIG. 4 a view corresponding to FIG. 2, in which value documents standing in the trough are shown,

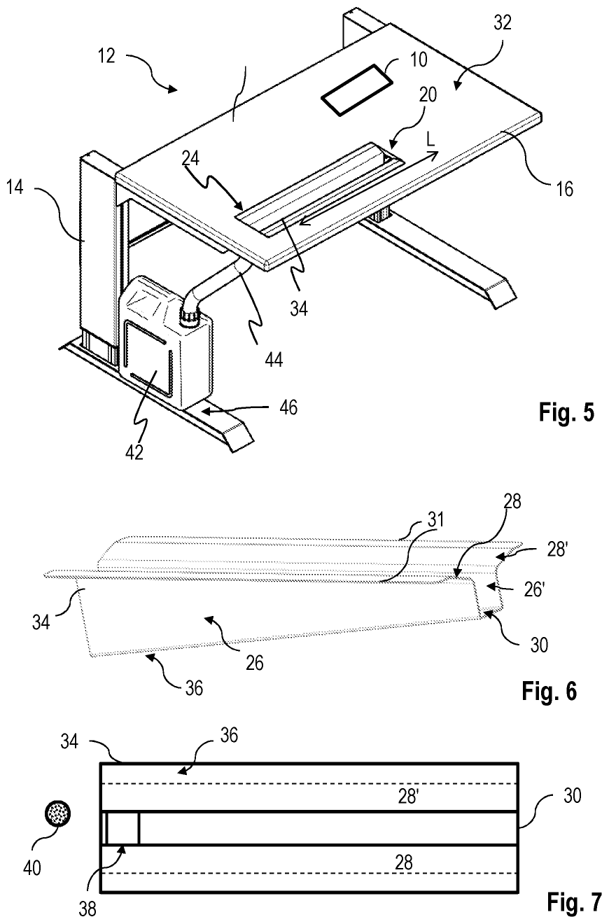

FIG. 5 a perspective schematic view of a second example of an apparatus for arranging value documents with a coin container,

FIG. 6 a perspective view of a profile rail, which serves as the trough in the apparatus in FIG. 5,

FIG. 7 a schematic plan view of the profile rail in FIG. 6, and

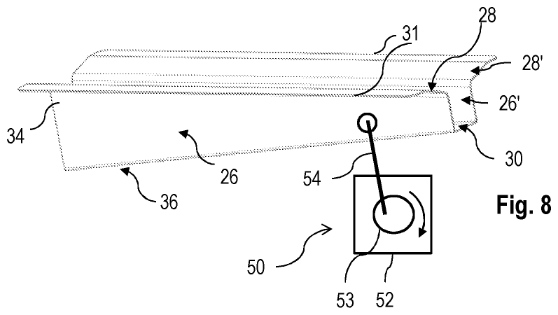

FIG. 8 a schematic perspective view of a profile rail, which serves as the trough in the apparatus in FIG. 5, and a vibration device coupled thereto.

In FIG. 1, an apparatus for arranging value documents 10 comprises a table 12 having on a support frame 14 a table top 16 which has a work surface 18 on which value documents to be arranged can be placed.

The work surface 18 or its surface is structured such that a user can grip below the value documents with his fingertips and can pick these up more easily. In this example, the work surface 18 is nubby and therefore has nubs 19.

In the work surface 18 a trough 20 is configured such that value documents 10 picked up or pushed from the work surface 18 can be brought into said trough in order to mutually align them therein and to arrange them to form stacks preferably.

The trough 20 is formed by a profile rail 22, in the example an aluminum profile, which is inserted in an elongated rectangular recess 24 in the table top 16 (see FIG. 2). The length of the profile rail 22 in the direction L and that of the recess can be between 30 cm and 90 cm, in the example it amounts to about 60 cm.

The profile rail 22 is embedded in the table top 16 such that its upper edge is flush with the work surface 18 or the surface of the table top 16. In this embodiment example, the profile rail 22 and thus the trough 20 is configured symmetrically; in FIG. 2 a cross section orthogonal to the longitudinal direction L is illustrated.

The profile rail 22 and thus the trough 20 has on mutually opposing sides respectively two mutually adjoining wall sections 26 and 28 or 26′ and 28′, which extend in the longitudinal direction L of the trough.

The wall sections 26 and 26′ adjoin the bottom 30 and extend substantially parallel to each other. The spacing b of the wall sections 26 and 26′, and thus the width of the trough in their region above the bottom 30 amounts to between 20 mm and 40 mm, in the example 35 mm. The height c of the wall sections 26 and 26′ is in the range between 30 and 50 mm, in this example it amounts to 45 mm.

Further, the trough 20 is configured such that its width (transversely to the longitudinal direction) increases upwardly. More exactly, the profile rail 22 and thus the trough 20 has wall sections 28 and 28′ extending in the longitudinal direction L of the trough 20, each of which adjoining the wall sections 26 and 26′ extending parallel to each other, and being inclined with respect to the work surface 18 at an angle x between 15° and 45°. In the example the angle amounts to about 20°.

The width a of the profile rail 22 and thus the width of the trough 20 in the region of the opening or at the level of the work surface 18 can be between 100 mm and 120 mm, in the example it amounts to 110 mm.

For arranging value documents 10, these are put by hand into the trough 20, where they stand on their edges or corners, but are not aligned parallel to each other (see. FIGS. 3 and 4). In particular, the trough 20 prevents a tipping over of the value documents 10 with the substantially parallel wall sections 26 and 26′, between which the value documents 10 stand. Thus, these are held at least approximately upright. Using both hands, the value documents standing in the trough 20 can now be moved against each other for example by rotating or pushing, and can be mutually aligned, wherein the bottom 30 of the trough 20 serves as support. When the value documents 10 are aligned parallel to each other for example with their longitudinal edges and stand on the bottom 30 of the trough 20 with these edges, they can be pushed together by moving the hands parallel to the longitudinal direction L of the trough 20 to form a stack. This stack can then be removed.

A second embodiment example in FIG. 5 differs from the first embodiment example in that, firstly, the work surface 32 is not structured but is flat, which can facilitate the shifting of value documents on the work surface.

On the other hand, the embodiment example differs from the first embodiment example in that the trough 20, more exactly the bottom 30, is inclined downwardly in the longitudinal direction L of the trough 20, so that coins can slide therein to the lower end.

FIG. 6 shows a perspective view of a profile rail 34, which is used instead of the profile rail 22 in the first embodiment example, and forms the trough 20. The bottom 30 is inclined with respect to the upper edges 31 of the profile rail, the wall sections 26 and 26′ extending parallel to each other have a trapezoidal shape with variable height. The wall sections 28 and 28′ are unchanged.

Further, the trough 20 has an opening 38 at its lower end through which the coins 40 can pass. At the opening 38 a transport device in the form of a hose 44 is arranged which leads to a coin receiving device, in the example a coin collection container 42, said hose being connected to the opening 38 and leading to the coin collection container 42 or its coin accepting opening. The coin collection container 42 is held on a receptacle 46 for the coin collection container. The opening 38, transport means, coin collection container 42 and receptacle 44 are configured and arranged such that coins 40 dropping through the opening 38 can enter the coin collection container 42 by means of the transport device, for example by sliding.

A third embodiment example differs from the first embodiment example in that the table top 16 and thus the work surface 18 is inclined in the direction of the trough 20, so that value documents 10 lying on the work surface 18 at least partially slide into the trough 20 or can be pushed into the trough when lying on the work surface.

A fourth embodiment example differs from the second embodiment example in that the apparatus comprises a vibration device, by means of which the trough 20 can be vibrated. Thereby an alignment of the value documents is simplified and in the favorable case effected at least largely automatically. FIG. 8 shows by way of example and in simplified manner a trough 20, which is coupled to a vibration device 50. The trough 20 or profile rail 34 does not differ from the trough in the previous example, but is embedded in the table top 16 such that an upward and downward movement is possible with its less deep end, on the right in FIG. 8, while the opposite end rests at least approximately. At the right end the vibration device 50 is held on the table top 16 and 50 has a drive 52 with a drive element 53, in the example a drive disk. The drive 52 is mechanically coupled to the trough 20 via a coupling element 54, in the example a rod, which is eccentrically but pivotally coupled to the drive element 53 and to the trough 20 via a hinge or hinged thereto. By the drive 52, in the example by the motor-driven rotation of the drive element 53, the coupling element 54 is moved, which thus generates a vibrating movement of the trough 20. By the arrangement on the one end, on the right in FIG. 8, a tilting movement of the trough 20 about the other end is produced, so that a vibrating movement is produced, which transfers vertical and horizontal movement components to banknotes therein. These are then conveyed to the other end, on the left in FIG. 8. Other embodiment examples differ from the described one in that the trough 20 is mounted so as to be rotatable about an axis transversal to the longitudinal direction of the trough 20 by means of a hinge at the end which is further away from the connection to the coupling element 54. Of course, other, possibly more elaborate mountings of the trough 20 and vibration devices are possible. The trough can also be configured like in the first embodiment.

A fifth embodiment example differs from the second embodiment example in that the coin receiving device is not the coin receiving container 42, but said container is replaced by a coin sorting device, at whose coin feed the transport device 44, in the example the hose, ends.

1.-8. (canceled)

9. An apparatus for arranging value documents with
a work surface on which value documents to be arranged can be placed, and
a trough in or in front of the work surface which is configured such that value documents picked up or pushed from the work surface can be brought into said trough, in order to mutually align them therein.

10. The apparatus according to claim 9, wherein the trough has mutually opposing wall sections extending in the longitudinal direction of the trough, which extend substantially parallel to each other.

11. The apparatus according to claim 9, wherein the trough has wall sections extending in the longitudinal direction of the trough, which are inclined with respect to the work surface at an angle of between 15° and 45°.

12. The apparatus according to claim 9, wherein the trough, preferably at one end, has an opening,
wherein preferably at the opening a transport device is arranged for transporting coins which have entered through the opening and/or a coin receiving device or a receptacle for a coin receiving device is arranged such that coins dropping through the opening can drop into a coin receiving device received therein, and preferably at least the bottom of the trough is inclined downwardly in the longitudinal direction of the trough, so that the opening is disposed at the lower end.

13. The apparatus according to claim 9, wherein the work surface is inclined in the direction of the trough, so that value documents lying on the work surface at least partially slide into the trough or can be pushed into the trough when lying on the work surface.

14. The apparatus according to claim 9, wherein the work surface is structured, preferably ribbed or nubby, such that a user can grip with his fingertips below the value documents and pick these up more easily.

15. The apparatus according to claim 9, which has a device by means of which the trough can be vibrated.

16. A method for arranging value documents, preferably forming a stack of the value documents, wherein the value documents are brought onto a work surface of an apparatus according to claim 9,
the value documents are moved from the work surface into the trough and the value documents are mutually aligned in the trough.
